(19) United States
(12) Patent Application Publication
(10) Pub. No.: US 2012/0327379 A1
(43) Pub. Date: Dec. 27, 2012

(54) IMAGE DISPLAY APPARATUS

(75) Inventors: Hirofumi ENOMOTO, Kumamoto (JP); Yoshihiro TESHIMA, Fukuoka (JP); Junichi MUTOH, Fukuoka (JP)

(73) Assignee: PANASONIC CORPORATION, Osaka (JP)

(21) Appl. No.: 13/367,586

(22) Filed: Feb. 7, 2012

(30) Foreign Application Priority Data
Jun. 27, 2011 (JP) 2011-142080
Jun. 27, 2011 (JP) 2011-142107

(51) Int. Cl. G03B 21/16

(52) U.S. Cl. 353/52

(57) ABSTRACT

An image display apparatus including a laser light source apparatus with a semiconductor laser as a light source increases the heat releasing ability of the laser light source apparatus in the image display apparatus. In order to accomplish this, a heat sink is provided to a green color laser light source apparatus, which generates green color light by wavelength conversion from infrared light and, therefore, produces a greater amount of heat than the other laser light source apparatuses. In addition, an air flow blocking cover is mounted on the surface of the holder, covering the temperature sensor, to prevent distribution to the temperature sensor of cooling air from the cooling fan disposed adjacent to the red color laser light source apparatus. It is thus possible to comply with laser safety standards.

### CROSS-REFERENCE TO RELATED APPLICATIONS

The present application claims priority under 35 U.S.C. §119 of Japanese Application No. 2011-142107, filed on Jun. 27, 2011, and of Japanese Application No. 2011-142080, filed on Jun. 27, 2011, the disclosures of which are expressly incorporated by reference herein in their entirety.

### BACKGROUND OF THE INVENTION

1. Field of the Invention

In order to control temperature changes in a laser light source apparatus, the present invention relates to an image display apparatus in which a temperature sensor is mounted to the laser light source apparatus employing a semiconductor laser, and further relates to an image display apparatus which includes a heat releasing member.

2. Description of Related Art

In recent years, focus has been on technology employing a semiconductor laser as a light source for a projection-type image display apparatus which projects an image onto a screen. A semiconductor laser has various advantages as compared to a mercury lamp conventionally used in an image display apparatus, such as good color reproducibility, instantaneous light-up, long life, the ability to reduce power consumption at a high efficiency, and ease of miniaturization.

In an image display apparatus employing a semiconductor laser, such as that disclosed in Japanese Patent Laid-open Publication 2007-316393, three laser light source apparatuses for a red color, a green color, and a blue color and a spatial light modulating element composed of a single liquid crystal display element are employed in order to form a color image. A technique is known using a time-divisional display system (field sequential system) in which laser light of each color emitted from a respective laser light source apparatus is sequentially incident on the spatial light modulating element. The time-divisional display system allows images of each color projected onto the screen to be recognized as a color image due to an afterimage effect in the eye. A single spatial light modulating element is sufficient for the time-divisional display system, and accordingly the system is convenient for miniaturization of an apparatus.

Of the laser light source apparatuses employed in such an image display apparatus, a laser light source apparatus for each of a red color and a blue color may employ a CAN package configuration which includes a semiconductor laser emitting laser light. However, due to the difficulty of mass producing a semiconductor laser emitting a pure green color laser light, a green color laser light source apparatus may employ, for example, a solid-state laser element and a wavelength conversion element to emit green color laser light, the solid-state laser element emitting infrared laser light and the wavelength conversion element converting the wavelength of the infrared laser light and emitting half-wavelength laser light, which constitutes green color laser light.

The green color laser light source apparatus having such a configuration produces green color light by converting the wavelength of infrared light as described above. Therefore, the amount of heat generated is greater than the other semiconductor lasers for a red color and a blue color. For this reason, providing the green color laser light source apparatus with a heat releasing member to increase its heat releasing ability may be considered. However, when a heat-releasing surface area is simply broadened in order to increase the heat releasing ability of the heat releasing member, a circumstance arises in which the image display apparatus increases in size.

Furthermore, because laser light causes damage upon entering the eye, standards have been established regarding the safety of laser products (IEC 60825-1). Specifications complying with these safety standards are desirable in the image display apparatus described above employing a semiconductor laser as a light source. In order to avoid having a negative effect on a user's health, a laser must be equivalent to a Class 1. However, a semiconductor laser has characteristics wherein light output grows greater with a drop in temperature, even when the applied current is the same. The energy concentration is high for a blue color laser in particular, and therefore the relevant safety standards are stricter than for other colors.

In order to limit light output, a sensor detecting light amount, for example, may be used. In such a case, during the adjustment process, when the energy concentration of light radiated to the exterior is adjusted to a pre-determined value within a range that does not exceed Class 1, the correlation is found between a drive electric current value of a semiconductor laser and a detected value (light amount) from the sensor detecting light amount. For example, at an ambient temperature of 25° C., the drive electric current value of the blue color semiconductor laser in particular is adjusted so as not to exceed Class 1 at an emission of 50 1 m.

However, the relationship between the drive electric current value of a semiconductor laser and the energy concentration of the light radiated to the exterior from the semiconductor laser is not constant, and fluctuates according to the temperature of the semiconductor laser itself This means that the fluctuation is dependent on the ambient temperature of the surroundings, of course, but also dependent on the amount of radiation time. Generally, the temperature of the semiconductor laser increases a little while after radiation has begun, rather than right at the start of radiation. To address this, a temperature sensor such as a thermistor may be mounted on the semiconductor laser and deviations in light amount may be corrected using the deviations in temperature between an adjustment time and a drive time.

On the other hand, in a case where a projector serves as the image display apparatus employing the semiconductor laser and is made installable in a notebook computer, small size and high luminosity are required. In such a case, mounting a temperature sensor on each of the red, green, and blue laser light source apparatuses is not only difficult because the mounting locations and wiring space are highly restricted, but manufacturing costs also rise sharply.

Moreover, cooling employing a cooling fan, for example, may be considered in order to inhibit a rise in temperature in the laser light source apparatus. However, depending on the relationship between the placement of the temperature sensor and the flow path of cooling air, the temperature detected by the temperature sensor may not be the actual temperature of the laser light source apparatus. Instead, the temperature sensor may detect a temperature cooled by the cooling air, and may diverge greatly from the actual temperature of the semiconductor laser.

### SUMMARY OF THE INVENTION

An advantage of the present invention is to provide an image display apparatus which increases the heat releasing ability of a laser light source apparatus and which is capable of being miniaturized.

In order to achieve this, the image display apparatus of the present invention includes a first laser light source apparatus which emits laser light of one of a red color, a green color, and a blue color; a second laser light source apparatus which emits one of another of the colors of laser light; a third laser light source apparatus which emits the remaining color of laser light; and a cooling fan which distributes cooling air which cools each of the laser light source apparatuses. The first laser light source apparatus includes a heat releasing member. The heat releasing member has a configuration integrally including a tubular portion and a wall portion. The wall portion extends from the tubular portion to catch the cooling air distributed from the cooling fan to guide the cooling air to the tubular portion, through which the cooling air passes. Accordingly, the heat releasing member distributes cooling air from the cooling fan to cool the laser light source apparatuses and the cooling ability of the heat releasing member is improved because the tubular portion through which the cooling air passes and the wall portion guiding the cooling air to the tubular portion are integrally provided on the heat releasing member. The heat releasing member may be provided, for example, on the laser light source apparatus among each of a red color, green color, and blue color that produces the greatest amount of heat. A configuration in which cooling air is distributed to the other laser light source apparatuses is possible and, in addition, due to the tubular portion having a shape through which the cooling air passes, there are no projecting portions as in a heat releasing member provided with fins. The heat releasing member may thus be easily made compact, as well.

It is desirable that the cooling air distributed from the cooling fan be configured to flow across the back in the optical axis direction of the first laser light source apparatus to reach the wall portion, then that the wall portion alter the flow toward the tubular portion positioned on a side in the optical axis direction of the first laser light source apparatus. Moreover, it is desirable that the tubular portion have an axial direction length of a roughly equal length to the first laser light source apparatus. It is further desirable that the wall portion be formed with a length projecting out from the first laser light source apparatus. Accordingly, in a case where the heat releasing member has been mounted on the first laser light source apparatus, it is possible to catch the cooling air with the wall portion projecting from the first laser light source apparatus. It is further possible to favorably guide the cooling air along the wall portion to the tubular portion.

Yet further, it is preferable that one of the second and third laser light source apparatuses be disposed on a downstream side of the cooling air with respect to the heat releasing member. Thereby, due to the configuration of the heat releasing member in which cooling air passes through the tubular portion, a flow of cooling air develops downstream from the tubular portion. Moreover, the directionality of the flow of cooling air may be stabilized by passing through the tubular portion, and thus the distribution of cooling air to the laser light source apparatuses provided downstream may also be stabilized, and cooling ability may be improved.

In order to provide an image display apparatus which increases the heat releasing ability of a laser light source apparatus and which is also able to be miniaturized, the image display apparatus of the present invention includes a first laser light source apparatus emitting one of a red color, a green color, and a blue color laser light; a second laser light source apparatus emitting one of the other colors of laser light; and a third laser light source apparatus emitting the remaining color of laser light. The image display apparatus further includes a cooling fan delivering cooling air to cool each laser light source apparatus; a temperature sensor detecting the temperature of the second laser light source apparatus; and an air flow blocker preventing the distribution of cooling air to the temperature sensor.

With this configuration, when a red color semiconductor laser is employed in the second laser light source apparatus, there is a tendency for light emission of the red color semiconductor laser to drop increasingly as temperature rises. Therefore, a greater amount of cooling air is delivered to the red color laser light source apparatus in order to inhibit a rise in temperature. A temperature sensor is mounted to the second laser light source apparatus in order to reliably control the temperature of the red color laser light source apparatus. In addition, an air flow blocker is provided protecting the temperature sensor from the cooling air such that the temperature sensor is not affected by the cooling air. Accordingly, the temperature of the second laser light source apparatus may be accurately detected. In addition, the temperature of the first and third laser light source apparatuses may be accurately estimated without mounting individual temperature sensors thereon.

It is desirable that the temperature sensor be mounted on a surface of the second laser light source apparatus and that the air flow blocker be an air flow blocking cover mounted on the surface of the second laser light source apparatus. Thus, when the temperature sensor has been mounted on a surface of, for example, a case (holder) of the red color laser light source apparatus in order to simplify the mounting of the temperature sensor, the air flow blocking cover, which blocks the cooling air directed at the temperature sensor, is able to have a simple shape by mounting the air flow blocking cover on the same surface.

The second laser light source apparatus and a drive control circuit are connected via a flexible cable. It is desirable that the portion of the flexible cable connected to the second laser light source apparatus be fixed in place by being held between the surface of the second laser light source apparatus and the air flow blocking cover. The portion at which the flexible cable is fixed to the second laser light source apparatus is thereby held between the holder supporting the second laser light source apparatus and the air flow blocking cover, the flexible cable electrically connecting the second laser light source apparatus and the drive control circuit. By fixing the air flow blocking cover in place at the holder, the two may be fixed in place together and there is no need for a separate fixing element for the flexible cable. The cost of components may thus be decreased.

Moreover, it is desirable that the air flow blocking cover have a recessed portion formed so as to accommodate the temperature sensor by surrounding at least roughly the entire outer periphery of the temperature sensor. The entire body of the temperature sensor may thus be covered by the air flow blocking cover. Further, a case may be prevented in which the temperature sensor itself is cooled by cooling air reaching the temperature sensor, causing the temperature sensor to no longer detect an accurate temperature. In addition, as long as the cooling air does not directly contact the temperature sensor, there is no negative circumstance when a portion of a wall formed by the recessed portion opens in a direction other than the upstream side of the cooling air.

Another advantage of the present invention is to provide an image display apparatus which preserves the quality of a projected image and also complies with laser safety standards, and which is capable of being miniaturized.

In order to accomplish this, the image display apparatus of the present invention further includes the drive control circuit controlling each emission of the semiconductor lasers. The drive control circuit estimates the temperature of the third laser light source apparatus using a detected temperature value from the temperature sensor for the second laser light source apparatus, then controls the emission of the third laser light source apparatus based on the estimated value.

With this configuration, during the control to limit the light amount of the blue color laser light, for which safety standards are stricter than for other colors, the temperature of the third laser light source apparatus emitting blue color laser light may be estimated using the detected temperature value of the second laser light source apparatus because the temperature/light emission characteristics of the blue color semiconductor laser change in a similar manner to those of the red color semiconductor laser. The emission of the third laser light source apparatus may thus be controlled. Accordingly, appropriate control of light emission with respect to changes in temperature of the red color semiconductor laser and the blue color semiconductor laser becomes possible, and a temperature sensor for the third laser light source apparatus may be omitted. It is thus possible to promote compactness of the apparatus and lower costs.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a perspective view illustrating an example of an image display apparatus 1 according to the present invention installed in a portable information processing apparatus 2;

FIG. 2 is an exploded perspective view of an optical engine unit 13;

FIG. 3 is a schematic view of the structure of an optical engine 21 installed in the optical engine unit 13;

FIG. 4 is a block diagram illustrating the functions of the image display apparatus 1;

FIG. 5 illustrates a waveform of an electric current applied to semiconductor lasers for each laser light source apparatus 22-24;

FIG. 6 illustrates a relationship between a use temperature T and a light emission P for each laser light source apparatus 22-24;

FIG. 7A illustrates a change in response to a temperature for an amount of light emitted from a semiconductor laser;

FIG. 7B illustrates a change in response to a temperature for a drive electric current applied to a semiconductor laser;

FIG. 8 is a plan view of an image display apparatus with a cover plate removed;

FIG. 9 is a flowchart illustrating steps of electric current control for a semiconductor laser 50 in a blue color laser light source apparatus 24;

FIG. 10 is a temperature coefficient table for finding a maximum electric current value I2;

FIG. 11 is a perspective view of a red color laser light source apparatus 23 and an air flow blocking cover 81;

FIG. 12 is an exploded perspective view of the air flow blocking cover 81 mounted on the red color laser light source apparatus 23;

FIG. 13A is a front view of the air flow blocking cover 81 mounted on the red color laser light source apparatus 23;

FIG. 13B is a cross-sectional view of FIG. 13A as seen along a line of arrows XIIIb-XIIIb;

FIG. 13C is a cross-sectional view of FIG. 13A as seen along a line of arrows XIIIc-XIIIc;

FIG. 14 is an exploded perspective view of a green color laser light source apparatus 22 and a heat sink 85;

FIG. 15 is a perspective view of the heat sink 85 mounted on the green color laser light source apparatus 22; and

FIG. 16 is a cross-sectional view of a tubular portion 85a in the heat sink 85.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

Hereinafter, an embodiment of the present invention is described with reference to the drawings.

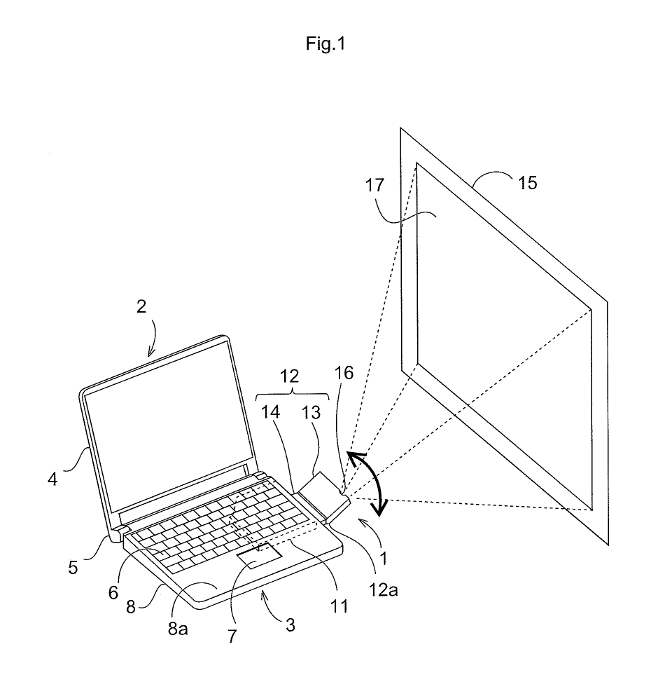

FIG. 1 is a perspective view illustrating an example of an image display apparatus 1 according to the present invention installed in a portable information processing apparatus 2. The portable information processing apparatus 2 includes a main body 3 and a display 4. A control board (not shown in the drawings) is installed in the main body 3, the control board mounted with a CPU, a memory, and the like. The display 4 is provided with a liquid crystal panel. The main body 3 and the display 4 are connected by a hinge 5. The main body 3 and the display 4 may be folded over to overlay one another, thus increasing portability. A commercially available notebook computer may be applied as an example of the portable information processing apparatus 2.

A keyboard 6 and a touchpad 7 are provided to a top surface 8a on a case 8 of the main body 3. A storage space (drive bay) is formed on the underside of the keyboard 6 in the case 8 of the main body 3. A peripheral device such as an optical disc apparatus and the like (a device performing recording and play-back, and at least play-back, of information on an optical disc such as a Blu-ray disc, a DVD, a CD, and the like) is stored in the storage space such that the device may be swapped out. The image display device 1 is mounted to the drive bay.

The image display apparatus 1 includes a case 11 and a movable body 12 provided so as to be insertable to and ejectable from the case 11. The movable body 12 is stored within the case 11 when the image display apparatus 1 is not in use. The movable body 12 is configured from an optical engine unit (projection unit) 13 and a control unit 14. The optical engine unit 13 stores optical components for projecting laser light onto a screen 15. The control unit 14 includes a drive control circuit storing a board and the like for controlling the optical components within the optical engine unit 13.

The optical engine unit 13 is supported by the control unit 14 so as to be rotatable in the vertical direction via a hinge 12a. The optical engine unit 13 is provided with an emission window 16 on an end of a side opposite to the hinge 12a, the emission window 16 emitting laser light. By rotating the optical engine unit 13 to adjust the projection angle of laser light from the optical engine unit 13, laser light is projected correctly on the screen 15 and an image 17 may be displayed on the screen 15.

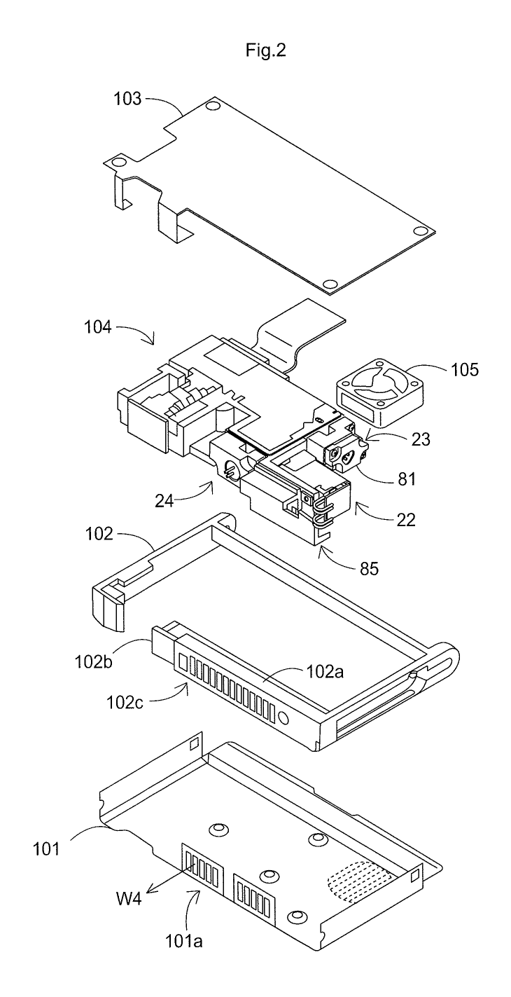

FIG. 2 illustrates an exploded perspective view of the optical engine unit 13. As shown in the figure, a casing is configured from a flat, rectangular base plate 101; a framing body 102 corresponding to the outer peripheral portion of the base plate 101; and a cover plate 103 covering the upper surface of the base plate 101 and the framing body 102. A unit main body 104 configuring an optical engine and a cooling fan 105 are stored within the casing.

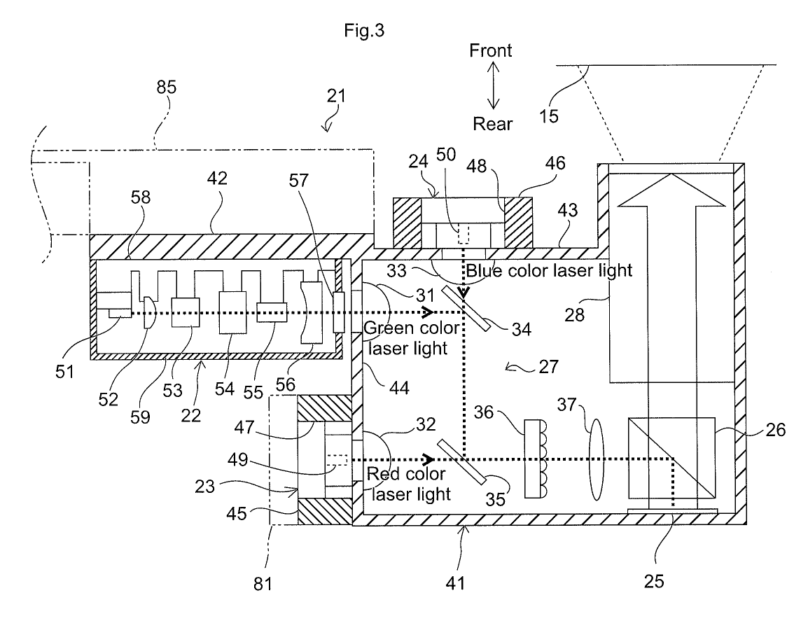

FIG. 3 is a schematic view of the structure of the optical engine 21 installed in the optical engine unit 13. The optical engine 21 includes a green color laser light source apparatus 22 emitting green color laser light; a red color laser light source apparatus 23 emitting red color laser light; a blue color laser light source apparatus 24 emitting blue color laser light; a spatial light modulating element 25; a polarization beam splitter 26; a relay optical system 27; and a projection optical apparatus 28. The spatial light modulating element 25 performs modulation of laser light from each of the laser light source apparatuses 22-24 in response to image signals. The polarization beam splitter 26 reflects laser light from each of the laser light source apparatuses 22-24 and shines the laser light onto the spatial light modulating element 25, and also transmits modulated laser light emitted from the spatial light modulating element 25. The relay optical system 27 guides laser light emitted from each of the laser light source apparatuses 22-24 onto the polarization beam splitter 26. The projection optical apparatus 28 includes a lens group for projecting onto a screen the modulated laser light transmitted by the polarization beam splitter 26. Each of these components is installed in a case 41 of the unit main body 104.

The optical engine 21 displays a color image using a field sequential system. Laser light of each color is sequentially output on a time-divisional basis from the respective laser light source apparatus 22-24 and the images from laser light of each color are recognized as a color image due to an afterimage effect in the eye.

The relay optical system 27 includes collimator lenses 31-33; a first dichroic mirror 34 and a second dichroic mirror 35; a diffuser plate 36; and a field lens 37. The collimator lenses 31-33 convert the laser light of each color emitted from the respective laser light source apparatus 22-24 into a parallel beam. The first dichroic mirror 34 and the second dichroic mirror 35 guide the laser light of each color which has passed through the collimator lenses 31-33 in a desired direction. The diffuser plate 36 diffuses the laser light guided by the dichroic mirrors 34 and 35. The field lens 37 converts the laser light which has passed through the diffuser plate 36 into a convergent laser.

Taking the side to which laser light is emitted toward a screen from the projection optical apparatus 28 as a front side, a holder 46 is attached to the outer surface of a front wall 43 of the case 41. Electric circuit components for the blue color laser light source apparatus 24 are held by the holder 46. The holder 46 also serves as a casing for the blue color laser light source apparatus 24. The blue color laser light from the blue color laser light source apparatus 24 is emitted to the rear within the case 41. The green color laser light source apparatus 22 and the red color laser light source apparatus 23 are positioned such that the optical axis of the green color laser light and the optical axis of the red color laser light are mutually orthogonal with respect to the optical axis of the blue color laser light.

The green color laser light source apparatus 22 is provided on a plate-shaped attachment portion 42 extending in a side direction from a corner between a front wall 43 of the case 41 and a side wall 44 orthogonal to the front wall 43. A holder 45 is mounted at a position to the rear of the green color laser light source apparatus 22 on the outer surface of the side wall 44. Electric circuit components for the red color laser light source apparatus 23 are held by the holder 45. The holder 45 also serves as a casing for the red color laser light source apparatus 23.

With this layout, the green color laser light from the green color laser light source apparatus 22 and the red color laser light from the red color laser light source apparatus 23 are each emitted in a direction orthogonal to the blue color laser light. The blue color laser light, the red color laser light, and the green color laser light are thus guided onto the same optical path by the two dichroic mirrors 34 and 35. Specifically, the blue color laser light and the green color laser light are guided onto the same optical path by the first dichroic mirror 34, and the blue color laser light, the green color laser light, and the red color laser light are guided onto the same optical path by the second dichroic mirror 35.

A film is formed on a surface of the first dichroic mirror 34 and the second dichroic mirror 35, the film transmitting and reflecting laser light of predetermined wavelengths. The first dichroic mirror 34 is positioned at a point where the blue color laser light and the green color laser light intersect, the mirror having an inclination of 45° relative to both optical paths, such that the blue color laser light passes through the mirror and the green color laser light is reflected by the mirror. The second dichroic mirror 35 is positioned at a point where the blue color laser light and the red color laser light intersect, the mirror having an inclination of 45° relative to both optical paths, such that the red color laser light passes through the mirror and the blue color laser light and the green color laser light are reflected by the mirror.

Each optical element is supported on the case 41 via a position fixing element, which is omitted from the figures. The case 41 acts as a heat releasing body releasing heat generated by each of the laser light source apparatuses 22-24, and is formed of a material such as aluminum, copper, and the like, having high thermal conductivity.

The red color laser light source apparatus 23 and the blue color laser light source apparatus 24 are configured in a CAN package. Semiconductor lasers 49 and 50, emitting laser light, are provided such that, supported by a stem, the optical axis of each is positioned on the central axis of a can-shaped exterior portion. Laser light is emitted from a glass window provided in an opening of the exterior portion. The red color laser light source apparatus 23 and the blue color laser light source apparatus 24 are fixed to the holders 45 and 46, respectively, by press-fitting into attachment holes 47 and 48, respectively. The attachment holes 47 and 48 are provided on the holders 45 and 46, respectively. Part of the heat generated by laser chips in the blue color laser light source apparatus 24 and in the red color laser light source apparatus 23 is transferred to the case 41 via the holders 45 and 46, and is thus released. Each of the holders 45 and 46 are formed of a material such as aluminum, copper, and the like, having high thermal conductivity.

The green color laser light source apparatus 22 includes a semiconductor laser 51; a FAC (Fast-Axis Collimator) lens 52 and a rod lens 53; a solid-state laser element 54; a wavelength conversion element 55; a concave mirror 56; a glass cover 57; a base 58 supporting each component; and a cover body 59 covering each component. The semiconductor laser 51 emits excitation laser light. The FAC lens 52 and the rod lens 53 are collection lenses collecting excitation laser light emitted from the semiconductor laser 51. The solid-state laser element 54 is excited by the excitation laser light and emits fundamental laser light (infrared laser light). The wavelength conversion element 55 converts the wavelength of the fundamental laser light and emits half-wavelength laser light (green color laser light). The concave mirror 56, together with the solid-state laser element 54, configures a resonator. The glass cover 57 prevents leakage of the excitation laser light and the fundamental wavelength laser light.

The green color laser light source apparatus 22 is fixed in place by the base 58 being attached to the attachment portion 42. The green color laser light source apparatus 22 is provided such that there is a space of a desired width (for example, 0.5 mm or less) between the green color laser light source apparatus 22 and the side wall 44 of the case 41. Due to this space, heat from the green color laser light source apparatus 22 is less likely to transfer to the red color laser light source apparatus 23 via the side wall 44. Thus, an increase in temperature in the red color laser light source apparatus 23 may be inhibited. Accordingly, the red color laser light source apparatus 23, which has negative temperature characteristics (light emission greatly decreases at high temperatures), may be operated stably at a low temperature range. In order to preserve a desired optical axis adjustment margin (for example, about 0.3 mm) for the red color laser light source apparatus 23, a gap of a desired width (for example, 0.3 mm or more) is provided between the green color laser light source apparatus 22 and the red color laser light source apparatus 23.

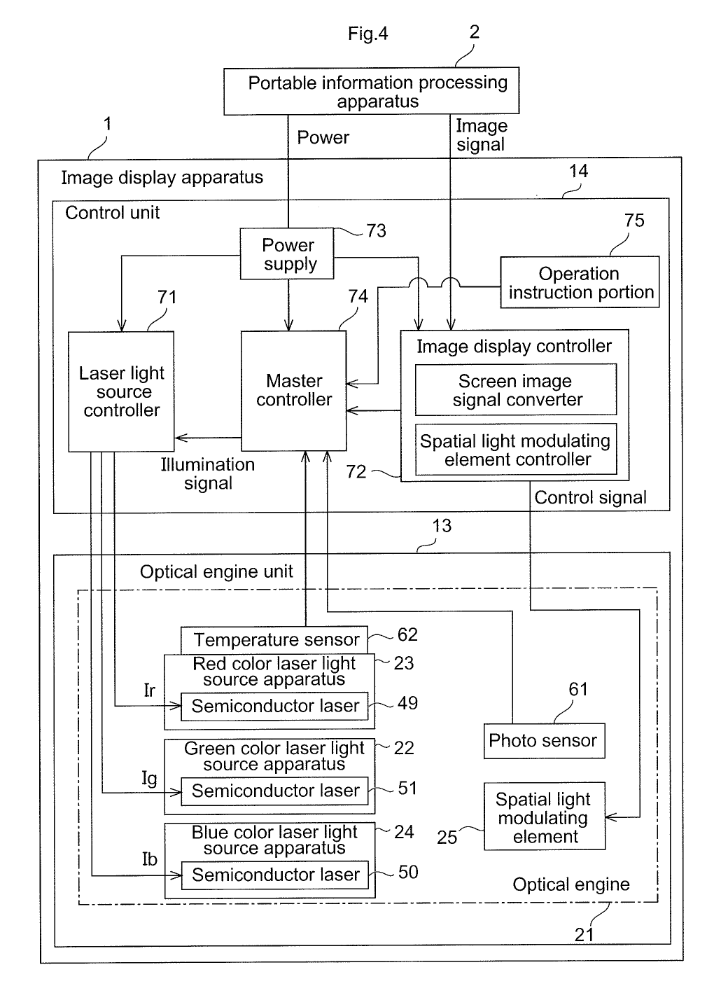

FIG. 4 is a block diagram illustrating the functions of the image display apparatus 1. In addition to the laser light source apparatuses 22-24 of each color and the spatial light modulating element 25, the optical engine 21 provided to the optical engine unit 13 includes a photosensor 61 and a temperature sensor 62. The photosensor 61 detects an amount of light incident on the light modulating element 25. The temperature sensor 62 detects a temperature of the red color laser light source apparatus 23.

The control unit 14 includes a laser light source controller 71 controlling the laser light source apparatuses 22-24 of each color; an image display controller 72; a power supply 73; and a master controller 74 performing overall control of each component. The image display controller 72 controls the spatial light modulating element 25 based on a screen image signal input from the portable information processing apparatus 2. The power supply 73 supplies electric power supplied from the portable information processing apparatus 2 to the laser light source controller 71 and to the image display controller 72.

Based on an image display signal input from the image display controller 72, the master controller 74 generates an illumination signal which acts as a control signal controlling illumination of the laser light source apparatuses 22-24 of each color, and outputs the illumination signal to the laser light source controller 71. The illumination signals are a red color signal, a green color signal, and a blue color signal respectively illuminating each of the red color, green color, and blue color laser light source apparatuses 22-24.

Based on the illumination signal input from the master controller 74, the laser light source controller 71 sequentially applies a drive electric current (Ig, Ir, and Ib) to the semiconductor laser of each laser light source apparatus 22-24. Each laser light source apparatus 22-24 then illuminates on a time-divisional basis. At this point, each drive electric current (Ig, Ir, and Ib) is controlled such that an upper limit is not exceeded. The upper limit is determined in response to a temperature indicated by the output signal of the temperature sensor 62. This will be explained in detail below.

Based on a screen image signal input from the portable information processing apparatus 2, the image display controller 72 generates control signals (a reference voltage signal and a pixel voltage signal) controlling the action of the spatial light modulating element 25. The image display controller 72 then outputs the control signals to the spatial light modulating element 25.

The spatial light modulating element 25 is an LCOS (Liquid Crystal On Silicon), a reflective-type liquid crystal display element. The spatial light modulating element 25 has a configuration reflecting and emitting laser light with a reflective layer on a silicon substrate, the laser light having passed through a liquid crystal layer formed on the silicon substrate. The output (brightness) of the laser light in the spatial light modulating element 25 increases and decreases in response to the control signal input from the image display controller 72. A desired hue may thus be displayed by varying the output of laser light of each color input on a time-divisional basis from each laser light source apparatus 22-24.

The control unit 14 includes an operation instruction portion 75. The operation instruction portion 75 includes a brightness adjustment button. The operation instruction portion 75 also includes a power button, a trapezoidal correction button, and the like.

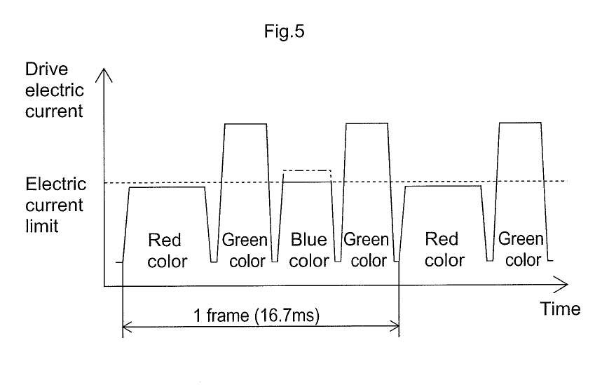

As shown in FIG. 5, in the present embodiment a drive electric current is sequentially applied to the semiconductor lasers 49-51 of the red color, green color, and blue color laser light source apparatuses 22-24, respectively. Each of the laser light source apparatuses 22-24 is then illuminated on a time-divisional basis. In particular, in the present embodiment, one frame is divided into four illumination intervals (subframes). In one frame, each of the laser light source apparatuses 22-24 is illuminated in the order red color, green color, blue color, green color.

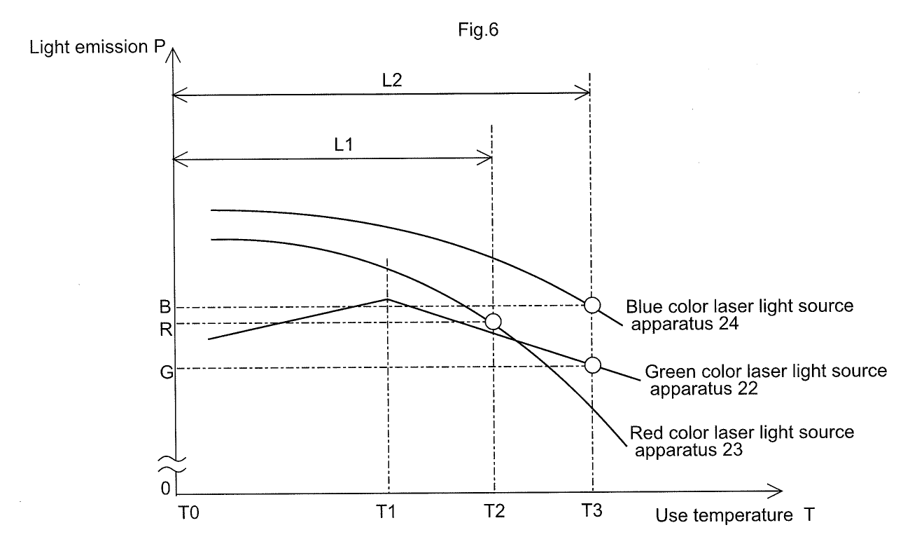

FIG. 6 illustrates a relationship between a use temperature T and a light emission P for each laser light source apparatus 22-24. A temperature TO may be a lower limit value of a range in which use of the image display apparatus 1 is possible within design specifications. As shown in FIG. 6, the light emission P for the green color laser light source apparatus 22 gradually increases in accordance with a rise in temperature from a low temperature side to a temperature T1. The light emission P for the green color laser light source apparatus 22 gradually decreases in accordance with a rise in temperature from the temperature T1 to a high temperature side. In contrast, the light emission P for the red color laser light source apparatus 23 is high at a low temperature side, decreases in accordance with a rise in temperature, and decreases greatly the higher the temperature becomes. The light emission P for the blue color laser light source apparatus 24 is also high at a low temperature side, decreases in accordance with a rise in temperature, and decreases greatly the higher the temperature becomes. However, the rate of decrease for the blue color laser light source apparatus 24 is less than for the red color laser light source apparatus 23.

Given these characteristics for each of the laser light source apparatuses 22-24, a level of the light emission P which causes no negative consequences during use is shown in FIG. 6 by G for the green color laser light source apparatus 22, R for the red color laser light source 23, and B for the blue color laser light source apparatus 24. A temperature range at which the light emission P is greater than or equal to each of the levels G, R, and B is a use range for each of the laser light source apparatuses 22-24. In FIG. 6, the upper limit of the use temperature T for the red color laser light source apparatus 23 is T2. The upper limit of the use temperature T for the green color laser light source apparatus 22 and the blue color laser light source apparatus 24 is T3.

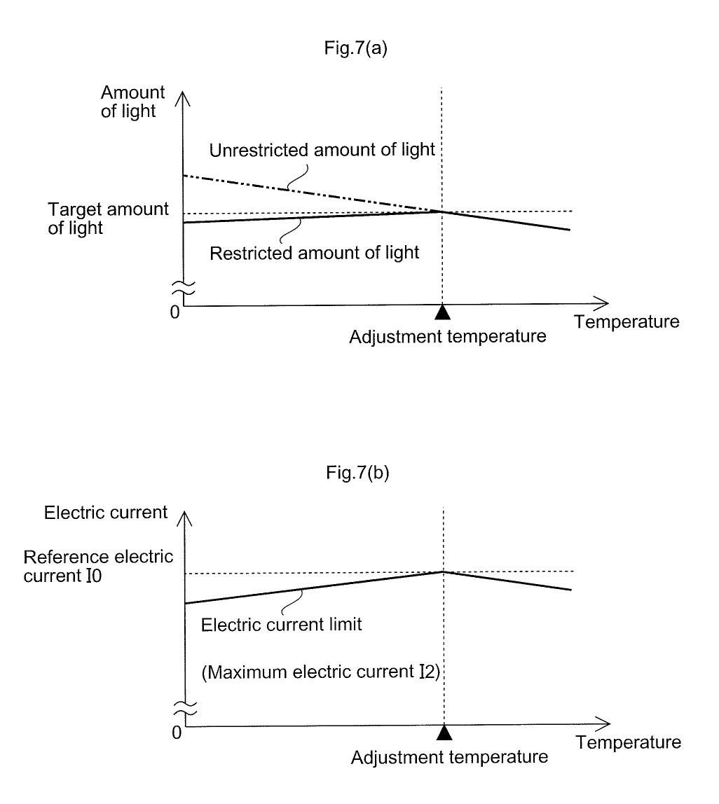

FIGS. 7A and 7B illustrate waveforms of a drive electric current applied to the semiconductor laser for each of the laser light source apparatuses 22-24. FIG. 7A illustrates a change in response to temperature for an amount of light emitted from the semiconductor laser. FIG. 7B illustrates a change in response to temperature for a drive electric current applied to the semiconductor laser.

In the present image display apparatus 1, the amount of light is restricted so as to comply with Class 1 of the IEC 60825-1 laser product safety standards. Because the possibility of deviating from the safety standards due to blue color laser light in particular is high, the present embodiment restricts the amount of blue color laser light. Following a light amount adjustment process restricting the amount of blue color laser light, white balance adjustment is performed and here the amounts of red color and green color laser light are also adjusted as necessary.

The amount of light for the blue color laser light source apparatus 24 is adjusted in an emission adjustment operation. In the emission adjustment operation, an amount of blue color laser light is detected by the photosensor 61, then a reference electric current value I0 (FIG. 7B) is defined. The reference electric current value I0 is the greatest value of the drive electric current within a range not exceeding an amount of emitted light stipulated by safety standards. Similar emission adjustment may be performed for the green color laser light source apparatus 22 and the red color laser light source apparatus 23, as well.

As shown in FIG. 7A, the semiconductor laser 50 for the blue color laser light source apparatus 24 has characteristics in which the amount of light emitted becomes greater in response to a decrease in temperature, even when the drive electric current is the same. Accordingly, when the temperature of the semiconductor laser 50 in a use state becomes lower than a temperature in the emission adjustment operation (for example, 25° C.; hereinafter referred to as adjustment temperatures), there is a possibility that the amount of emitted light will deviate from safety standards.

Therefore, as shown in FIG. 7B, when the temperature is lower than the adjustment temperature, it is necessary to restrict the drive electric current applied to the semiconductor laser 50 of the blue color laser light source apparatus 24. The drive electric current is restricted to be lower than the reference electric current value I0; that is, to be lower than the greatest electric current value in which the amount of emitted light at the adjustment temperature satisfies safety standards. Furthermore, in response to a decrease in temperature of the semiconductor laser 50, the drive electric current may be restricted such that the difference between the drive electric current and the reference electric current value I0 grows progressively greater. Accordingly, even when the temperature of the semiconductor laser 50 of the blue color laser light source apparatus 24 decreases, it is possible to avoid an amount of emitted light deviating from safety standards. At a temperature exceeding adjustment temperatures, the amount of emitted light lessens in response to a rise in temperature. Therefore, the drive electric current applied to the semiconductor laser 50 is kept at the reference electric current value I0.

There is variation in the amount of light due to individual differences in the semiconductor laser 50 of the blue color laser light source apparatus 24. This variation in the amount of light becomes greater in accordance with a decrease in the temperature of the semiconductor laser 50. In the present embodiment, as shown in FIG. 7A, the drive electric current is restricted such that the difference between the amount of emitted light and a target amount of light satisfying the safety standards becomes progressively greater in accordance with a decrease in temperature of the semiconductor laser 50. Accordingly, it is possible to confidently avoid the amount of light deviating from the safety standards because of variation in light amount due to individual differences.

In the present invention, a reference temperature for controlling the drive electric current of the blue color laser light source apparatus 24 is determined by the temperature of the red color laser light source apparatus 23. As shown in FIG. 4, the temperature sensor 62 is mounted to the red color laser light source apparatus 23.

As described above with reference to FIG. 6, changes in the respective light emissions in response to temperature show a similar tendency in both the red color laser light source apparatus 23 and the blue color laser light source apparatus 24. Accordingly, using a detected temperature t for the red color laser light source apparatus 23, it is possible to find a light emission Pb for the blue color laser light source apparatus 24 (Pb=f(t)). It is possible to find the light emission Pb by, for example, taking the quadratic function of the detected temperature t, by mapping, and the like.

In the image display apparatus 1 having a small profile and high brightness, as in the present embodiment, there are limitations on the layout of elements and it is difficult to mount a plurality of temperature sensors. In response, the temperature of the blue color laser light source apparatus 24 may be controlled by mounting the temperature sensor 62 only on the red color laser light source apparatus 23, as described above. There is no need to mount a temperature sensor on the blue color laser light source apparatus 24 and the compactness of the image display apparatus 1 is preserved.

As described above, there is a circumstance in the red color laser light source apparatus 23 in which the rate of decrease in light emission increases as the temperature becomes higher. As a result, as shown in FIG. 6, the temperature upper limit value T2 ensuring a rated light emission is lower than the temperature upper limit T3 ensuring a rated light emission in the blue color laser light source apparatus 24. Therefore, a temperature is detected in the red color light source apparatus 23, for which restrictions are more stringent at high temperatures. When the blue color laser light source apparatus 24 is controlled based on the detected temperature, it may be assumed that the temperature of the blue color laser light source apparatus 24 will never exceed the upper limit value T3. Control of the blue color laser light source apparatus 24 is possible by simply providing the temperature sensor 62 on the red color laser light source apparatus 23, and the number of temperature sensors to be attached may be minimized.

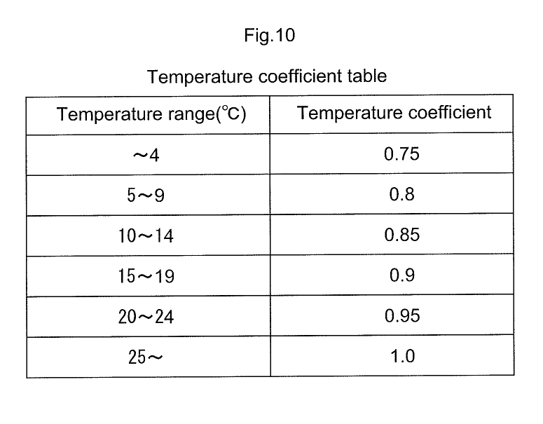

With respect to the red color laser light source apparatus 23, cooling capacity is increased in order to regulate temperatures below or equal to the temperature upper limit value T2 due to the temperature/light emission characteristics described above. In the depicted embodiment, as shown in FIGS. 3 and 10, the cooling fan 105 is positioned in the space bounded on two sides by the green color laser light source apparatus 22 and the red color laser light source apparatus 23. The cooling fan may thus be mounted by making use of the space formed by the difference in the amount of protrusion from the side wall 44 on the left side of the case 41 between the green color laser light source apparatus 22 and the red color laser light source apparatus 23.

The temperature used in regulating the green color laser light source apparatus 22 is also determined using the detected value of the temperature sensor 62. The light emission does not change greatly in response to the temperature of the green color laser light source apparatus 22 as it does in the red color laser light source apparatus 23, as described above. The green color laser light source apparatus 22 also does not have characteristics in which the light emission increases at low temperatures. Accordingly, the detected value from the temperature sensor 62 mounted on the red color laser light source apparatus 23 may be used as-is, or a value obtained by a simple formula multiplying by a factor, and the like, may be used as a temperature control reference value.

On the other hand, each of the laser light source apparatuses 22-24 has a tendency in which light emission decreases at high temperatures. Accordingly, it is necessary to prevent a rise in temperature in order to ensure rated emissions. The cooling fan 105 described above is provided for use in such cooling. Minimizing as much as possible the number of internal components is required for compactness of the image display apparatus 1. Due to this, only one cooling fan 105 is provided and its flow of cooling air is directed toward each of the laser light source apparatuses 22-24.

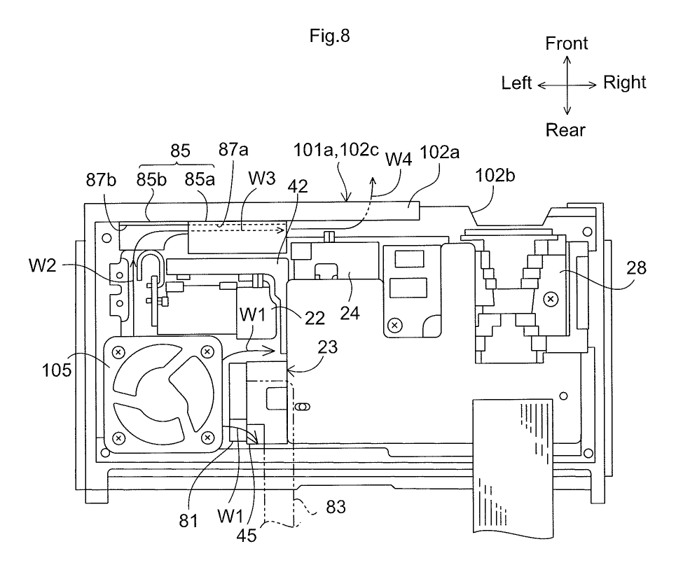

In FIG. 8, the casing of the cooling fan 105 has a rectangular shape in a planar view. The cooling fan 105 may be of a form that intakes from the rear surface side (base plate 101 side) in the figure and exhausts from a side surface of the cooling fan 105.

Air is distributed to the red color laser light source apparatus 23 as shown by an arrow W1 in FIG. 8. Air is distributed to the green color laser light source apparatus 22 as shown by an arrow W2 in FIG. 8. The flow W2 of cooling air which has passed the green color laser light source apparatus 22 changes direction toward the blue color laser light source apparatus 24 and flows as shown by an arrow W3 in FIG. 8.

By providing the cooling fan 105 in such a way, it is possible to blow cooling air onto the red color laser light source 23 at close proximity, the red color laser light source apparatus 23 requiring prioritized prevention of a rise in temperature due to the great decrease in light emission at high temperatures. It is thus possible to magnify the cooling effect on the red color laser light source apparatus 23.

FIG. 8 shows a state with the cover plate 103 (see FIG. 2) removed. In the present depicted embodiment, the attachment portion 42 supporting the green color laser light source apparatus 22 extends parallel to an opposing wall 102a of the framing body 102. The green color laser light source apparatus 22 is disposed on a side of the attachment portion 42 opposite from the side wall 102a. By attaching the cover plate 103, a space is formed bounded by the framing body 102 (see FIG. 2) and between the base plate 101 and the cover plate 103. Accordingly, a flow path may be formed by the gap created between the framing body 102 and the unit main body 104 (see FIG. 2). Due to this, the flow W2 of cooling air distributed to the green color laser light source apparatus 22 passes a side (front of FIG. 8) portion from a rear (left of FIG. 8) portion of the green color laser light source apparatus 22. The flow W2 of cooling air is then able to flow as shown by the dashed-line arrow W3 in FIG. 8.

The wall 102a is formed continuing to a location just before the projection optical apparatus 28, extending past the blue color laser light source apparatus 24 to the right side of FIG. 8. An opening 102b is formed by the termination of the wall 102a, the opening 102b serving to allow the optical path projected by the projection optical apparatus 28 to pass. As shown in FIG. 2, the wall 102a includes exhaust vents 102c, which are a plurality of openings in a line. In addition, the base plate 101 also includes exhaust vents 101a, which are a plurality of openings in a line, communicating with the exhaust vents 102c at a cut-out side which has been cut out to overlap with the wall 102a. The blue color laser light source apparatus 24 is provided on the flow path on which the flow W3 of cooling air flows, as described above. After the flow W3 of cooling air cools the blue color laser light source apparatus 24, the cooling air is exhausted outward from both exhaust vents 101a and 102c as shown by W4 in FIGS. 2 and 8.

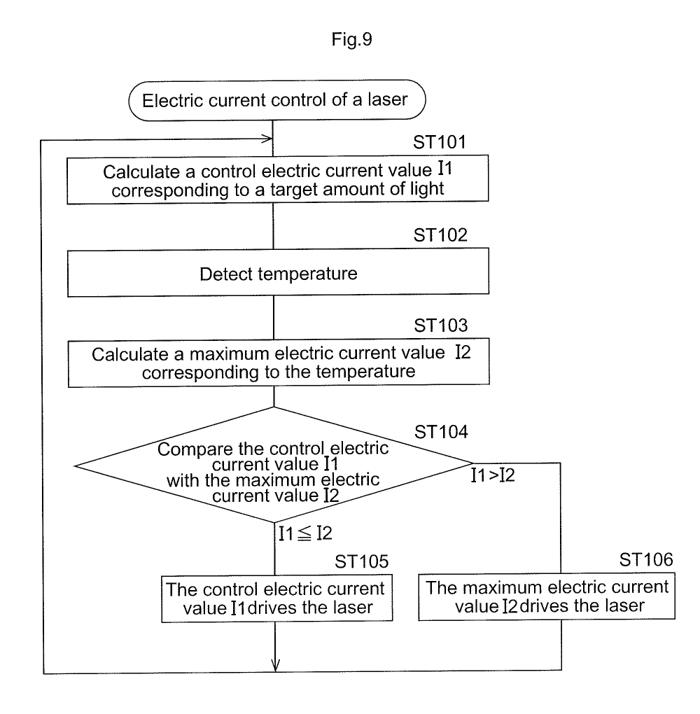

FIG. 9 is a flowchart illustrating steps of electric current control for the semiconductor laser 50 in the blue color laser light source apparatus 24. In the present embodiment, the drive electric current applied to the semiconductor laser 50 of the blue color laser light source apparatus 24 is controlled so that the drive electric current does not exceed an upper limit value (maximum electric current value I2) determined in response to a temperature indicated by an output signal from the temperature sensor 62.

Specifically, first, a control electric current value I1 corresponding to a target amount of light is calculated (ST101). The target amount of light is defined in response to brightness and the like instructed by operation of an operation button for brightness adjustment included in the operation instruction portion 75 (see FIG. 3). Next, a temperature is estimated using a mathematical function and the like as described above based on the output signal from the temperature sensor 62 (ST102), then the maximum electric current value I2 corresponding to the temperature is calculated (ST103).

The maximum electric current value I2 is compared with the control electric current value I1 (ST104) and, when the control electric current value I1 is equal to or less than the maximum electric current value I2, the control electric current value I1 drives the semiconductor laser 50 (ST105). When the control electric current value I1 is greater than the maximum electric current value I2, the maximum electric current value I2 drives the semiconductor laser 50 (ST106).

In the present embodiment, the control electric current value I1 is found with the following formula from a threshold electric current Ith of the semiconductor laser 50, a target light amount L0, and a constant E representing luminance efficiency of the semiconductor laser 50.

I1=L0/E+Ith

FIG. 10 illustrates a temperature coefficient table for finding a maximum electric current value I2. In the temperature coefficient table, a temperature coefficient K is determined for each predetermined temperature range. The reference electric current value I0 is then multiplied by the temperature coefficient K corresponding to a measured temperature to find the maximum electric current value I2, as in the following formula, where the reference electric current value I0 is the greatest electric current value for which the amount of light emitted at an adjustment temperature meets safety standards. In the temperature coefficient table, the temperature coefficient becomes smaller in response to the temperature lowering and the maximum electric current value I2 becomes smaller in response to the temperature lowering.

I2=I0×K

The maximum electric current value I2 may also be calculated with a formula having temperature as its parameter. It is also possible to use a table in which the maximum electric current value I2 is directly determined in response to a temperature.

The blue color laser light source apparatus 24 may thus be controlled. The blue color laser light source apparatus 24 is positioned further from the cooling fan 105 than the red color laser light source apparatus 23, in terms of the flow of cooling air. However, because the decrease in light emission at high temperatures is slight, as described above, it is possible to avoid insufficient cooling.

On the other hand, it is necessary to inhibit increases in temperature in the red color laser light source apparatus 23 due to the temperature/light emission relationship. The amount of airflow to the red color laser light source apparatus 23 is increased by providing the cooling fan 105 proximally thereto such that the cooling air blows onto the red color laser light source apparatus 23, as described above. However, when the cooling air is also blown onto the temperature sensor 62, the temperature sensor 62 is cooled. Thus, the temperature gradient grows larger between the red color laser light source apparatus 23 and the temperature sensor 62 which is on the holder 45 containing the red color laser light source apparatus 23. As a result, the temperature sensor 62 becomes unable to detect an accurate temperature for the red color laser light source apparatus 23.

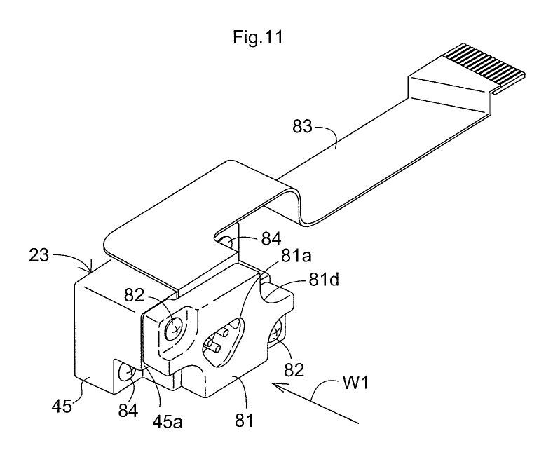

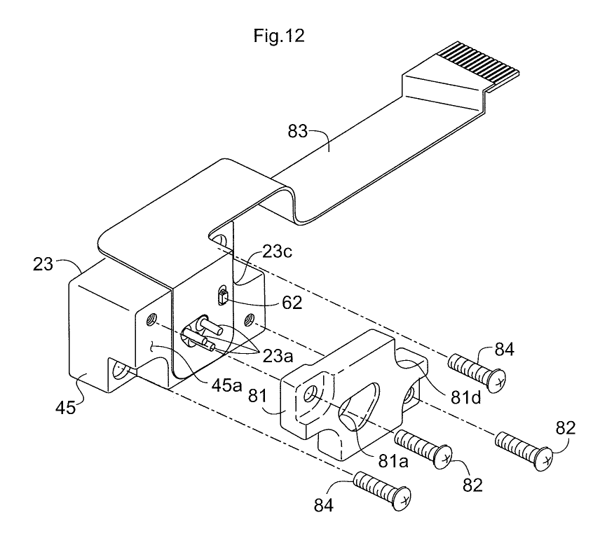

As shown in FIG. 11, the air flow blocking cover 81, acting as an air flow blocker, is attached to a surface 45a (a face opposing the flow W1 of cooling air) of the holder 45 for the red color laser light source apparatus 23. As shown in FIG. 12, the air flow blocking cover 81 is integrally attached to the holder 45 using, for example, two screws 82. In addition, in the present embodiment, the air flow blocking cover 81 is a separate body attaching to the holder 45; however, the air flow blocking cover 81 may also be integrally formed with the holder 45. In such a case, openings may be punched out. However, this may be managed by making the direction of the openings a direction orthogonal to the flow direction of the flow W1 of cooling air.

In the depicted embodiment, three pin terminals 23a are protrudingly provided from the surface 45a of the holder 45. One end portion 83a of a flexible cable 83 is soldered to the pin terminals 23a. The temperature sensor 62 is mounted on a surface of the end portion 83a of the flexible cable 83. The temperature sensor 62 may be a thermistor, for example. Accordingly, the space between the temperature sensor 62 and the holder 45 of the red color laser light source apparatus 23 is insulated by the interposition of the flexible cable 83. In addition, the adhesion of the temperature sensor 62 to the surface 45a of the holder 45 is increased by soldering the flexible cable 83 to the pin terminals 23a. Further, the portion of the end portion 83a of the flexible cable 83 which is soldered to the pin terminals 23a and the mounting portion of the temperature sensor 62 are each reinforced by reinforcing material on their back surfaces. The other end portion of the flexible cable 83 is connected to the control unit 14. The flexible cable 83 includes wirings connected both to the electrodes on both ends of the temperature sensor 62 and to the three pin terminals 23a of the red color laser light source apparatus 23. In this way, the temperature sensor 62 and the red color laser light source apparatus 23 are connected to the control unit 14.

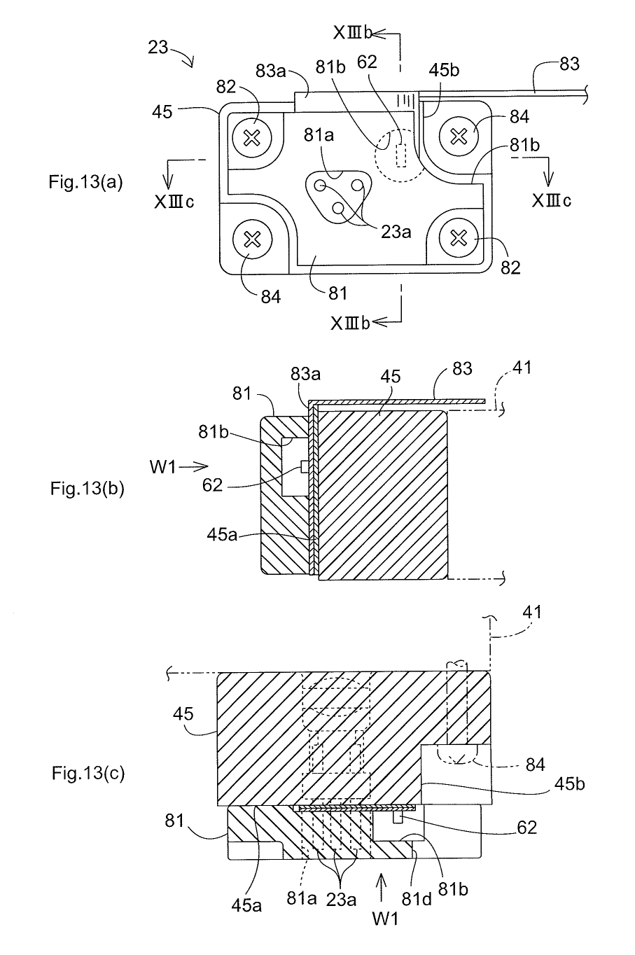

By mounting the air flow blocking cover 81 on the holder 45 of the red color laser light source apparatus 23, the end portion 83a of the flexible cable 83 is fixed in place by being held between the surface 45a of the holder 45 and the air flow blocking cover 81. As shown also in FIG. 13A, an opening 81a and a recessed portion 81b are formed on the air flow blocking cover 81, the opening 81a surrounding the three pin terminals 23a such that the three pin terminals 23a are inserted therethrough, and the recessed portion 81b accommodating the temperature sensor 62. As shown in FIG. 13B, the recessed portion 81b has a cavity shape with a bottom as viewed from the back side (the temperature sensor 62 side) of the air flow blocking cover 81.

As a portion for affixing to the case 41 with the screws 84, the holder 45 is formed with a pair of indentations 45b having a shelf shape, by recessing two diagonally opposed corners of the rectangular surface 45a. As shown in FIG. 13C, an indentation 81d is formed on the air flow blocking cover 81 in each position corresponding to the respective indentation 45b. The holes provided on the holder 45 to allow passage of the screws 84 are made larger than the circumference of the screws 84. Accordingly, the optical axis of the red color laser light source apparatus 23 may be adjusted two-dimensionally. In contrast, the screws 82 are used to fix the air flow blocking cover 81 in place on the holder 45, and the screws 82 are positioned at the diagonally opposed corners contrary to the screws 84.

In the depicted embodiment, as shown in FIGS. 13A and 13C, a portion of the inner peripheral wall on the cavity shape of the recessed portion 81b is cut away and the recessed portion 81b opens onto the indentation 81d. However, this is because of the difficulty of ensuring a thick space between the recessed portion 81b and the indentation 81d due to the compactness of the unit. Even when a portion opens to the exterior in this way, the recessed portion 81b may have a shape surrounding roughly the entire outer periphery of the temperature sensor 62 and, of course, a cavity shape having a base portion in which the entire outer periphery is enclosed is not excluded. However, when it is necessary to provide a portion which partially opens to the exterior due to issues of design specification, it is desirable that there be many components for which the direction of the opening of the communicating portion is orthogonal with respect to the flow W1 of cooling air (see FIG. 8). Alternatively, it is desirable that the communicating portion orient the direction of the opening in the same direction as the rotation base line direction of the cooling fan 105 (see FIG. 8), to which the continuous portion is opposed. The temperature sensor 62 is thus unlikely to directly receive cooling air delivered by the cooling fan 105 and the temperature sensor 62 is therefore able to more accurately detect the temperature of the red color laser light source apparatus 23.

Due to the air flow blocking cover 81 being shaped and mounted in this way, the flow W1 of cooling air toward the red color laser light source apparatus 23 is blocked by the air flow blocking cover 81 as shown in FIG. 13B. Thus, the flow W1 of cooling air does not blow directly onto the temperature sensor 62. Due to the recessed portion 81b securing the temperature sensor 62 with a sufficient margin, the portion of the air flow blocking cover 81 contacting the end portion 83a of the flexible cable 83 is small. The end portion 83a is also cooled by the air flow blocking cover 81 being cooled, and the temperature detection of the temperature sensor 62 is not negatively affected. Accordingly, the temperature sensor 62 is not actively cooled by the flow W1 of cooling air and thus the temperature sensor 62 is able to accurately detect the temperature of the red color laser light source apparatus 23.

The flow W1 of cooling air toward the temperature sensor 62 is blocked by the air flow blocking cover 81 as described above; however, a portion thereof flows into the indentation 81d and further flows through the indentation 45b and across the side surface of the red color laser light source apparatus 23. Heat produced by the red color laser light source apparatus 23 is transferred to the holder 45, then transferred to the air flow blocking cover 81 from the portion contacting the holder 45. Because the air flow blocking cover 81 is cooled by the flow W1 of cooling air, the cooling ability with respect to the red color laser light source apparatus 23 may be ensured. In addition, the air within the recessed portion 81b covering the temperature sensor 62 may be cooled by contact with the flow W1 of cooling air; however, it is a portion thereof and not to an extent that would cool the temperature sensor 62.

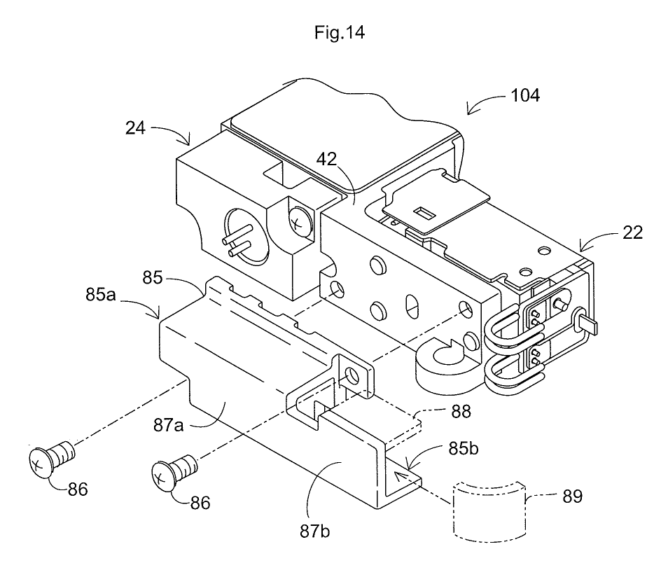

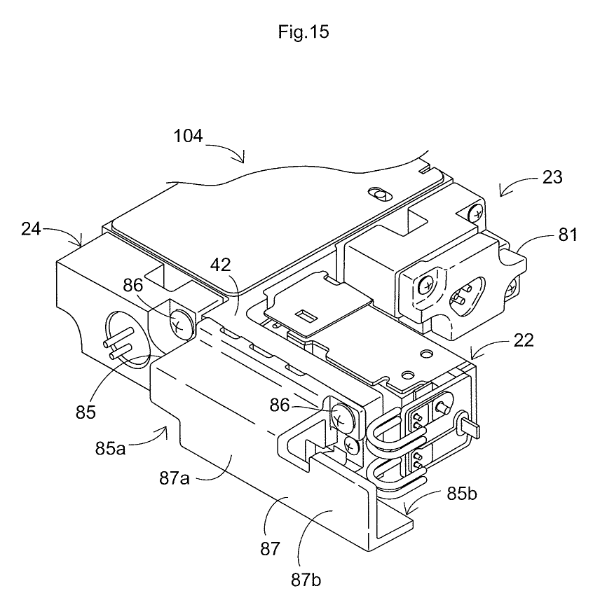

On the other hand, as illustrated in FIGS. 14 and 15, the heat sink 85 is mounted by screws 86 to the attachment portion 42 supporting the green color laser light source apparatus 22 as described above. The heat sink 85 is provided along the outer face (wall face on the front side in FIG. 8) of the plate-shaped attachment portion 42, running from the back side (left in FIG. 8) of the green color laser light source apparatus 22 to a position adjacent to the blue color laser light source apparatus 24. The heat sink 85 includes the tubular portion 85a and an L-shaped portion 85b. The tubular portion 85a has a squared cylindrical shape and is provided so as to extend along the length of an axial direction having the same length as the attachment portion 42, that is, the same length as the green color laser light source apparatus 22. The L-shaped portion 85b is configured with an outside wall portion 87a of the tubular portion 85a furthest from the green color laser light source apparatus 22 and a portion along the base plate 101, the L-shaped portion 85b extending to the back of the green color laser light source apparatus 22 from the tubular portion 85a.

By providing the heat sink 85 in this way, the heat produced by the green color laser light source apparatus 22 is transmitted to the heat sink 85 through the attachment portion 42. Thus, a rise in temperature in the green color laser light source apparatus 22 may be inhibited by the heat releasing effect of the heat sink 85. As described above, the green color laser light source apparatus 22 generates green color light by wavelength conversion from infrared light. Therefore, the amount of heat produced is greater than for the other laser light source apparatuses 23 and 24. In response, a great heat releasing effect may be enjoyed due to the heat sink 85.

Furthermore, as shown in FIG. 8, the flow W2 of cooling air reaches the L-shaped portion 85b of the heat sink 85 by flowing across the back (left in the figure) of the green color laser light source apparatus 22. The direction of the flow is altered toward the tubular portion 85a by a standing wall portion 87b on the L-shaped portion 85b, the standing wall portion 87b extending from the outer wall portion 87a of the tubular portion 85a. The flow W2 of cooling air thus becomes the flow W3 of cooling air passing over the tubular portion 85a. Accordingly, in addition to cooling the green color laser light source apparatus 22 with the flow W2 of cooling air, the heat sink 85 is cooled by the flow W3 of cooling air, thus promoting the heat releasing effect of the heat sink 85. Therefore, it is possible to inhibit a rise in temperature in the green color laser light source apparatus 22 far more favorably.

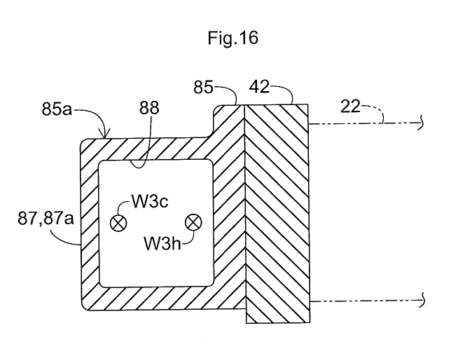

The flow W3 of cooling air passes through the inside of a flow path 88, the flow path 88 having a rectangular cross-section-shaped space demarcated by the tubular portion 85a and extending along a longitudinal direction of the green color laser light source apparatus 22. The flow W3 of cooling air then flows across the back end portion (front side in the figure) of the blue color laser light source apparatus 24, and is exhausted outward from the exhaust vents 101a and 102c as shown by W4 in FIGS. 2 and 8. The blue color laser light source apparatus 24 is cooled by this flow.

Where the flow of cooling air changes direction from the arrow W2 to the arrow W3 in FIG. 8, the flow turns, describing a curve. In that section, the flow passing in the vicinity of the back end portion of the green color laser light source apparatus 22 flows on the inner peripheral side of the curve. The flow passing a spot far from the green color laser light source apparatus 22 flows on the outer peripheral surface of the curve. For this reason, as shown in FIG. 16, in the tubular portion 85a of the heat sink 85, a comparatively low temperature flow W3c of cooling air is more likely to flow across a far side from the green color laser light source apparatus 22 and a comparatively high temperature flow W3h of cooling air is more likely to flow across a near side to the green color laser light source apparatus 22.

By forming the squared tubular portion 85a as in the depicted embodiment, the low temperature flow W3c of cooling air contacts the outer wall portion 87a on the far side from the green color laser light source apparatus 22. The cooling of the heat sink 85 by the flow W3 of cooling air can thus be further increased. Furthermore, in the depicted embodiment, the standing wall portion 87b in the L-shaped portion 85b is formed as a continuous portion of the outer wall portion 87a of the tubular portion 85a. The standing wall portion 87b of the L-shaped portion 85b is thus provided as a portion contacting the flow W2 of cooling air first and a broad area of heat transfer with respect to the low temperature flow W3c of cooling air is ensured.

The shape of the portion extending from the tubular portion 85a is not limited to the L shape of the present depicted embodiment. As illustrated by the two-dot-dashed line in FIG. 14, for example, a ceiling member 88 may be included; alternatively, the L-shaped portion may be formed in an integral U shape. Further, a guide member 89 may also be included on an end portion of the L-shaped portion 85b to guide the flow of air toward the heat sink 85, the guide member 89 having a curving arc surface. Accordingly, the flow W2 of cooling air may be directed toward the flow W3 of cooling air with much greater efficiency.

The image display apparatus according to the present invention is able to prevent a decrease in detection accuracy by attempting to block cooling air from directly touching a temperature sensor mounted on a red color laser light source apparatus when cooling by the flow of cooling air is performed on the red color laser light source apparatus. The image display apparatus according to the present invention is therefore useful in an image display apparatus seeking to be compact. The image display apparatus according to the present invention also provides a heat releasing member to a laser light source apparatus producing the greatest amount of heat, and a structure in which cooling air is distributed to the other laser light source apparatuses is possible. The image display apparatus according to the present invention is therefore useful in an image display apparatus seeking to be compact.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. An image display apparatus employing a semiconductor laser as a light source, comprising:
a red color laser light source apparatus emitting red color laser light;
a green color laser light source apparatus emitting green color laser light;
a blue color laser light source apparatus emitting blue color laser light;
a cooling fan delivering cooling air that cools each color laser light source apparatuses;
a temperature sensor detecting a temperature of the red color laser light source apparatus; and
an air flow blocker preventing the distribution of cooling air to the temperature sensor.

2. The image display apparatus according to claim 1, further comprising:
a drive control circuit controlling each emission of the semiconductor lasers,
wherein the drive control circuit estimates the temperature of the blue color laser light source apparatus using a detected temperature value from the temperature sensor for the red color laser light source apparatus, and then controls the emission of the blue color laser light source apparatus based on the estimated value.

3. The image display apparatus according to claim 1, wherein the temperature sensor is mounted to a surface of the red color laser light source apparatus; and
the air flow blocker is an air flow blocking cover mounted on the surface of the red color laser light source apparatus.

4. The image display apparatus according to claim 3, wherein the red color laser light source apparatus and a drive control circuit are connected via a flexible cable; and
the portion of the flexible cable connected to the red color laser light source apparatus is fixed in place by being held between the surface of the red color laser light source apparatus and the air flow blocking cover.

5. The image display apparatus according to claim 3, wherein the air flow blocking cover has a recessed portion formed so as to accommodate the temperature sensor by surrounding at least roughly the entire outer periphery of the temperature sensor.

6. The image display apparatus according to claim 1, wherein a heat releasing member is provided to the green color laser light source apparatus;
the heat releasing member integrally including a tubular portion and a wall portion, the wall portion extending from the tubular portion to catch the cooling air distributed from the cooling fan and to guide the cooling air to the tubular portion, through which the cooling air passes.

7. The image display apparatus according to claim 6, wherein the cooling air distributed from the cooling fan flows across the back in the optical axis direction of the green color laser light source apparatus to reach the wall portion, then the wall portion alters the flow toward the tubular portion positioned on a side in the optical axis direction of the green color laser light source apparatus.

8. The image display apparatus according to claim 6, wherein the tubular portion has an axial direction length of a roughly equal length to the green color laser light source apparatus; and
the wall portion is formed with a length projecting out from the green color laser light source apparatus.

9. The image display apparatus according to claim 6, wherein either one of the blue color laser light source apparatus and the red color laser light source apparatus is disposed on a downstream side of the cooling air with respect to the heat releasing member.

10. An image display apparatus employing a semiconductor laser as a light source, comprising:
a first laser light source apparatus emitting one of a red color, a green color, and a blue color laser light;
a second laser light source apparatus emitting one of another of the colors of laser light;
a third laser light source apparatus emitting the remaining color of laser light; and
a cooling fan distributing cooling air that cools each of the laser light source apparatuses,
wherein the first laser light source apparatus is provided with the heat releasing member, and
the heat releasing member integrally includes a tubular portion and a wall portion, the wall portion extending from the tubular portion to catch the cooling air distributed from the cooling fan and to guide the cooling air to the tubular portion, through which the cooling air passes.

11. The image display apparatus according to claim 10, wherein the cooling air distributed from the cooling fan flows across the back in the optical axis direction of the first laser light source apparatus to reach the wall portion, and then the wall portion alters the flow toward the tubular portion positioned on a side in the optical axis direction of the first laser light source apparatus.

12. The image display apparatus according to claim 10, wherein the tubular portion has an axial direction length of a roughly equal length to the first laser light source apparatus; and
the wall portion is formed with a length projecting out from the first laser light source apparatus.

13. The image display apparatus according to claim 10, wherein either one of the second laser light source apparatus and the third laser light source apparatus is disposed on a downstream side of the cooling air with respect to the heat releasing member.

14. The image display apparatus according to claim 10, further comprising:
a temperature sensor detecting a temperature of the second laser light source apparatus; and
an air flow blocker preventing the distribution of cooling air to the temperature sensor.

15. The image display apparatus according to claim 14, further comprising:
a drive control circuit controlling each emission of the semiconductor lasers,
wherein the drive control circuit estimates the temperature of the third laser light source apparatus using a detected temperature value from the temperature sensor for the second laser light source apparatus, and then controls the emission of the third laser light source apparatus based on the estimated value.

16. The image display apparatus according to claim 14, wherein the temperature sensor is mounted to a surface of the second laser light source apparatus; and
the air flow blocker is an air flow blocking cover mounted on the surface of the second laser light source apparatus.

17. The image display apparatus according to claim 16, wherein the second laser light source apparatus and the drive control circuit are connected via a flexible cable; and
the portion of the flexible cable connected to the second laser light source apparatus is fixed in place by being held between the surface of the second laser light source apparatus and the air flow blocking cover.

18. The image display apparatus according to claim 16, wherein the air flow blocking cover has a recessed portion formed so as to accommodate the temperature sensor by surrounding at least roughly the entire outer periphery of the temperature sensor.
